(19) United States
(12) Patent Application Publication
(10) Pub. No.: US 2005/0243703 A1
(43) Pub. Date: Nov. 3, 2005

(54) Disc comprising a substrate having a support plate and a registration layer connected to the support plate

(75) Inventors: Michael Adrianus Henricus Van Der Aa, Eindhoven (NL); Gerard Johannes Pieter Nijsse, Eindhoven (NL); Gerardus Lucien Mathildus Jansen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/520,194

(22) PCT Filed: Jun. 24, 2003
(86) PCT No.: PCT/IB03/02706

§ 371 Date: Jan. 4, 2005

(30) Foreign Application Priority Data
Jul. 8, 2002 (EP) 02077730.6

(51) Int. Cl. G11B 7/24

(52) U.S. Cl. 369/275.5

(57) ABSTRACT

A disc comprising a substrate layer which comprises a support plate and a registration layer connected to the support plate. A protective plate is situated at the side of the registration layer remote from the support plate, which protective plate can be detachably fastened to the substrate layer. The support plate is disc-shaped and is provided with at least one raised edge extending upwards from a circumferential edge, by means of which the protective plate can be detachably fastened.

The invention relates to a disc comprising a substrate layer that comprises a support plate and a registration layer connected to the support plate.

Such an optical disc known from Dutch patent application NL-8300476 comprises a support plate, a registration layer lying on the support plate, and a covering layer located at a distance from the registration layer. The covering layer in the known optical disc has the purpose of providing a gastight space in combination with the registration carrier, such that the registration carrier is protected against the ambient atmosphere.

In this known optical disc, however, the registration layer is not well protected against mechanical loads which occur, for example, in the case of impacts.

An object of the invention is to provide a device which protects the registration layer of a disc better so as to prevent damage to the registration layer.

This object is achieved in the disc according to the invention in that a protective plate is located at the side of the registration layer remote from the support plate, which protective plate can be detachably fastened to the substrate layer.

The advantage of a protective plate that can be detachably fastened is that the registration layer is protected by the protective plate situated on the substrate layer when the disc need not be written or read. Prior to reading or writing of the registration layer, the detachably fastened protective plate is to be removed, such that the registration layer becomes accessible.

An embodiment of the disc according to the invention is characterized in that the support plate has the shape of a disc and is provided with at least one raised edge extending upwards from a circumferential edge, by means of which the protective plate can be detachably fastened.

An advantage of such an embodiment is that the edge protects a lateral side of the disc against external influences. In addition, the raised edge satisfactorily absorbs forces which are exerted on the plate, for example in the case of an impact or drop.

A further embodiment of the disc according to the invention is characterized in that the protective plate can be magnetically fastened to the substrate layer.

It is an advantage of such an embodiment that the substrate layer and the protective plate are fastened to one another in a simple manner by means of at least one magnet. In addition, a magnet may be provided both in the protective plate and in the substrate layer, in which case the protective plate or the substrate layer may have a planar disc shape.

A yet further embodiment of the disc according to the invention is characterized in that the protective plate can be fastened to the substrate layer by means of interlocking shapes or force connections.

An advantage of such an embodiment is that the protective plate can be fastened to the substrate layer in a comparatively simple manner.

Another embodiment of the disc according to the invention is characterized in that the substrate layer can be inserted into a protective element which comprises at least the protective plate.

An advantage of such an embodiment is that, when the substrate layer is present inside the protective element, said protective element protects the entire substrate layer against external influences.

Yet another embodiment of the disc according to the invention is characterized in that at least an outer circumferential edge of the substrate layer or of the protective plate is provided with a groove.

An advantage of such an embodiment is that the groove can act as a point of application for a rail or a similar element whereby the substrate layer or the protective plate can be gripped, such that the substrate layer and the protective plate can be separated from one another in a simple manner.

The invention will be explained in more detail with reference to the accompanying drawings, in which:

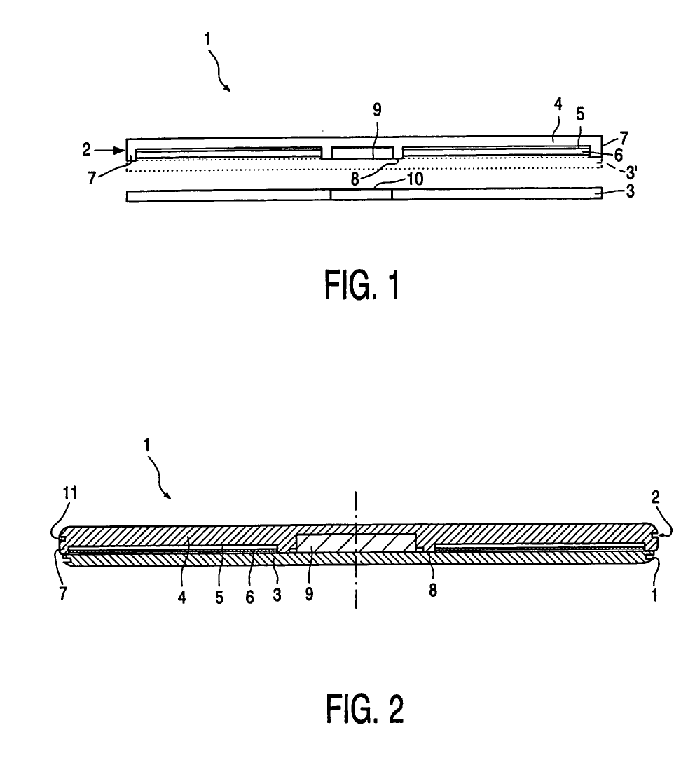

FIG. 1 is a diagrammatic cross-sectional view of a first embodiment of a disc according to the invention,

FIG. 2 is a diagrammatic cross-sectional view of a second embodiment of a disc according to the invention,

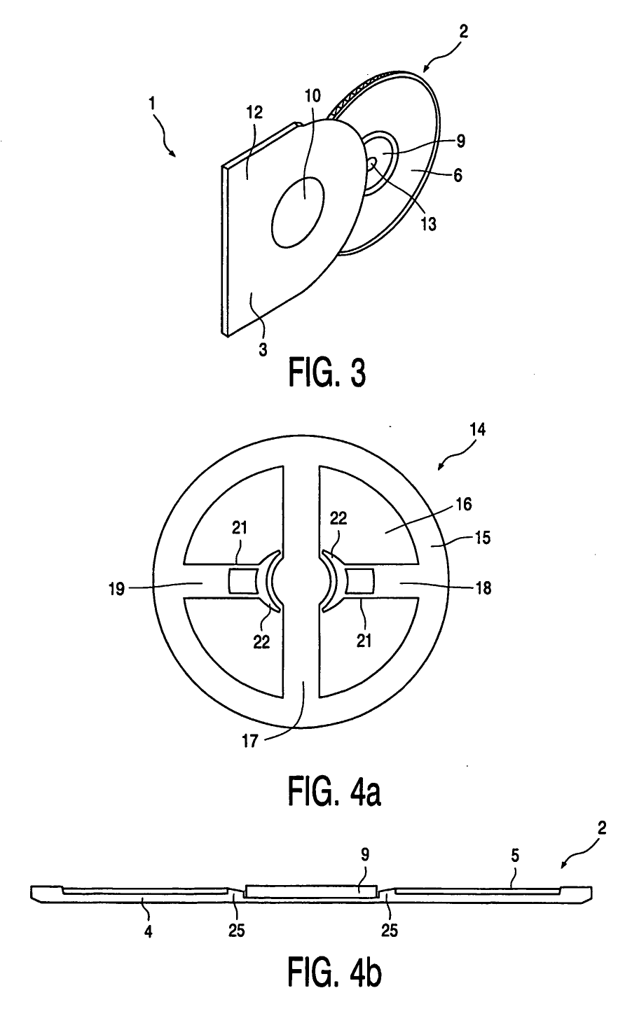

FIG. 3 is a perspective lateral view of a third embodiment of a disc according to the invention,

FIG. 4a is a diagrammatic plan view of an embodiment of a protective plate, and

FIG. 4b is a diagrammatic cross-sectional view of an embodiment of a substrate layer on which the plate of FIG. 4a can be fastened.

Corresponding components have been given the same reference numerals in the Figures.

FIG. 1 is a diagrammatic cross-sectional view of a first embodiment of an optical disc 1 according to the invention. The optical disc 1 comprises a substrate layer 2 and a protective plate 3 that can be detachably coupled thereto. The circular substrate layer 2 comprises a support plate 4, a registration layer 5 connected thereto, and a covering layer 6 connected to the registration layer 5 at a side of the registration layer 5 remote from the support plate 4. The support plate 4 is provided with a raised edge 7 on the outer circumferential edge and with a raised edge 8 located adjacent the centerline of the support plate 4. The registration layer 5 and the covering layer 6 provided thereon are situated between the raised edges 7 and 8 of the support plate 4. The covering layer 6 connected to the registration layer 5 ensures that a medium with which the disc 1 is read or written, such as a laser (not shown), is not hampered by any dust particles. Without the covering layer 6, the dust particles would be present immediately on the registration layer 5, which would render the registration layer 5 badly readable/writable. The covering layer 6, which is thin compared with the support plate 4, is manufactured from a material transparent to a reading or writing medium. The support plate 4 is manufactured from a hard material, for example metal or synthetic resin. The registration layer 5 is manufactured from materials for optical registration which are known per se. A magnet 9 surrounded by the central raised edges 8 is situated in the center of the support plate 4.

A protective plate 3, which can be detachably connected to the substrate layer 2, is located opposite the substrate layer 2 at the side remote from the support plate 4. A magnet 10 is arranged in the central portion of the protective plate 3.

The function of the protective plate 3 will now be briefly explained. To protect the registration layer 5, the protective plate is moved from the side of the covering layer 6, i.e. from the position shown in continuous lines, into the position shown with dotted lines denoting the protective plate 3′, where the protective plate 3′ is detachably fastened to the support plate 4 by means of the magnets 9, 10. The protective plate 3 is positioned as well as retained on the substrate layer 2 by means of the magnets 9, 10.

The protective plate 3′ bears on the raised edges 7, 8 of the support plate 4, which edges together absorb external forces exerted on the optical disc 1. In addition, the raised edges 7 of the support plate 4 provide a lateral protection of the registration layer 5. The registration layer 5 is effectively protected against external physical influences by the protective plate 3 and the raised edges 7.

When the optical disc 1 is to be written or read, the protective plate 3 is to be removed from the substrate layer 2, for example by means of a gripper device or the like.

FIG. 2 is a diagrammatic cross-sectional view of a second embodiment of an optical disc 1 according to the invention. The protective plate 3 and the substrate layer 2 differ from the first embodiment in that grooves 11 are located in the circumferential edges, so that external means, for example rails to be inserted into the grooves, are capable of separating the protective plate 3 and the substrate layer 2 from one another. In addition, the metal protective plate 3 does not comprise a magnet, but is drawn against the support plate 4 by the magnet 9 located in the support plate 4.

FIG. 3 is a perspective lateral view of a third embodiment of an optical disc 1 according to the invention. The optical disc 1 in this embodiment comprises a sleeve-type protective element 12 and a substrate layer 2. The substrate layer 2 has the same construction as in one of the preceding Figures. The sleeve-type protective element 12 comprises the protective plate 3 and the magnet 10. The substrate layer 2 is passed into the sleeve-type protective element 12 for protection purposes. The substrate layer 2 is substantially entirely enclosed and protected by the protective element 12.

The advantage of a comparatively sturdy protective element 12 is that the support plate 4 need not be manufactured from a hard material, because the protective element 12 encloses the substrate layer 2 in its entirety and absorbs external forces originating from all directions.

The optical disc 1 is provided with an opening 13 in the center of the substrate layer 2, by means of which the substrate layer 2 can be positioned on a turntable (not shown) on which the registration layer 5 can be written and read.

FIG. 4a is a diagrammatic plan view of an embodiment of a protective plate 14 according to the invention. The protective plate 14 comprises a metal ring 15 and a transparent, disc-shaped part 16 situated thereon. The ring 15 comprises a first strip 17 which extends diametrically across the ring 15. The ring is further provided with a second and a third strip 18, 19 which extend from the ring 15 transversely to the strip 17 towards the center of the ring 15. The second and the third strip 18, 19 are each provided adjacent the center with two parallel resilient bridges 21 extending towards the first strip 17, which bridges are connected to crescent-shaped ends 22 of the strips 18, 19 at a side facing away from the ring 15. The strips 17, 18, 19 are manufactured from soft magnetic material.

FIG. 4b is a diagrammatic cross-sectional view of an embodiment of a substrate layer 2. The substrate layer 2 comprises the same components as the substrate layers 2 of the embodiments shown in FIGS. 1 and 2, with the proviso that the embodiment shown in FIG. 4 is provided with a raised edge 25 located-adjacent the centerline, the end of said raised edge sloping downwards towards the magnet at a small angle. The support plate 4 is manufactured from a soft magnetic material in this embodiment.

When the protective plate 14 shown in FIG. 4a is positioned on the substrate layer 2 shown in FIG. 4b, the strip 17 of soft magnetic material of the protective plate 14 is attracted towards the substrate layer 2 by the magnet 9. The crescent-shaped ends 22 of the strips 18, 19 are drawn against the sloping inner raised edge 25 of the substrate layer 2 counter to the spring force of the bridges 21. The protective plate 14 is placed in the correct position with respect to the substrate 2 by means of the crescent-shaped ends 22 enclosing the round magnet 9, whereby a mutual displacement is effectively prevented. The force of attraction between the magnet 9 and the magnetic material of the strip 17 retains the protective plate 14 against the substrate layer 2.

The optical discs according to the invention may have the dimensions of a coin, while having a data capacity of approximately 1 gigabyte. This ratio of dimension to capacity renders the optical discs suitable for use in comparatively small appliances with memory-dependent applications such as, for example, mobile telephones.

It is alternatively possible, however, that mechanical means such as, for example, a closing tag or the like, are used for retaining the substrate layer 2 in the protective element 12 shown in FIG. 3.

It is furthermore possible that the disc is not provided with an opening 13, but that instead the disc can be positioned and handled by its outer circumferential edge.

It is alternatively possible to use a magneto-optical disc, a magnetic disc, or the like instead of an optical disc.

It is also possible that the disc 1 is not provided with a covering layer 6, for example in the case of a magnetic disc.

It is furthermore possible to use a single magnet instead of the magnets 9, 10, and to manufacture the part to be fastened thereby from a soft magnetic material.

It is also possible to provide the protective element 12 with two protective plates 3, each provided with a magnet 10.

1. A disc comprising a substrate layer that comprises a support plate and a registration layer connected to the support plate, characterized in that a protective plate is located at the side of the registration layer remote from the support plate, which protective plate can be detachably fastened to the substrate layer.

2. A disc as claimed in claim 1, characterized in that the support plate has the shape of a disc and is provided with at least one raised edge extending upwards from a circumferential edge, by means of which the protective plate can be detachably fastened.

3. A disc as claimed in claim 1, characterized in that the protective plate can be magnetically fastened to the substrate layer.

4. A disc as claimed in claim 1, characterized in that the protective plate shapes or force connections.

5. A disc as claimed in claim 1, characterized in that the substrate layer can be inserted into a protective element which comprises at least the protective plate.

6. A disc as claimed in claim 1, characterized in that at least an outer circumferential edge of the substrate layer or of the protective plate is provided with a groove.

7. A disc as claimed in claim 1, characterized in that the registration layer is provided with a covering layer at a side facing away from the support plate.
